(19) United States
(12) Patent Application Publication
(10) Pub. No.: US 2004/0145491 A1
(43) Pub. Date: Jul. 29, 2004

(54) Key fob communicator

(75) Inventor: Christopher J. Nascimento, Rochester Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI

(21) Appl. No.: 10/351,171

(22) Filed: Jan. 23, 2003

(51) Int. Cl. G08C 19/00

(52) U.S. Cl. 340/825.72; 361/600; 455/73

(57) ABSTRACT

A wireless vehicle device control and two-way voice communication system includes a portable fob and a vehicle unit. The fob includes a fob speaker and a fob transceiver, wherein the fob may be configured to transmit a fob user voice signal and at least one control signal, and receive at least one vehicle occupant voice signal. The vehicle unit includes a vehicle transceiver and at least one vehicle speaker, wherein the vehicle transceiver may be configured to transmit the at least one vehicle occupant voice signal, receive the fob user voice signal and the at least one control signal, and control at least one vehicle device in response to the control signal.

### BACKGROUND OF THE INVENTION

1. Field of the Invention

The present invention generally relates to a vehicle key fob communicator with a vehicle control interface.

2. Background Art

Remote keyless entry (RKE) systems are commonly integrated with vehicle locking systems to allow a user to lock and unlock vehicle doors, trunks, and control alarm systems without the need to use a key. The transmitter devices in such systems typically include a small, handheld transmitter housing in the form of a key fob that can be easily mounted to a user's key chain. One or more small switch buttons are located on the housing to allow the user to send the desired control signals to a receiver unit mounted on the vehicle (i.e., actively).

While such RKE arrangements have significantly increased user convenience, these systems still require a user to physically grab the transmitter housing and actuate a switch button thereon. However, there are times when neither hand is readily free, thereby requiring the user to put down items they may have been carrying so that the transmitter can be grasped. As a consequence, a need exists for a RKE transmitter that can be operated “hands-free” (i.e., passively). There are also occasions when a user who leaves the vehicle wishes to communicate with one or more vehicle occupants who have remained in the vehicle. Conventional RKE systems fail to provide a way for the parties to have two-way voice communication.

Attempts have been made to provide a “hands-free” (or passive) wireless-type lock control system that involve replacing the transmitter device with a passive transponder unit. One example of a “hands-free” wireless-type lock control system is disclosed in U.S. Pat. No. 5,929,769 to Garnault. In the Garnault system a transmitter unit is located on the vehicle, and is arranged to communicate with a transponder carried by the user when ever the transponder is within a predetermined vicinity of the transmitter. If the transponder is authorized, the transmitter will control opening or unlocking of the vehicle member. The problems with such “passive” systems are that they are generally limited only to opening or unlocking operations and require the user to be in very close proximity to the receiver. The passive system do not provide the user who leaves the vehicle carrying the key fob and the vehicle occupants who remain in the vehicle a way to have two-way voice communication.

Further, some vehicle RKE type systems are configured to provide a keyless vehicle ignition interface (e.g., keyless start). One example of a keyless vehicle ignition system is disclosed in U.S. Pat. No. 5,937,065 to Simon et al. However, keyless vehicle ignition systems such as the system disclosed by Simon et al., as with the other conventional RKE approaches, do not provide the user who leaves the vehicle carrying the key fob and the vehicle occupants who remain in the vehicle a way to conduct two-way voice communication (except, perhaps, vocally over a limited range).

Thus, there exists a need for a vehicle key fob and vehicle system that provides wireless “hands free” (or passive) or alternatively, active keyless vehicle device or operation control features, passive vehicle ignition interface capability, and two-way voice communication between a user who is not in the vehicle and one or more vehicle occupants.

### SUMMARY OF THE INVENTION

Accordingly, the present invention provides an improved system and an improved method for a vehicle key fob in connection with a vehicle that provides wireless “hands free” (or passive) or alternatively, active keyless vehicle device or operation control features, passive vehicle ignition interface capability, and two-way voice communication between a user who is not in the vehicle and at least one vehicle occupant.

According to the present invention, a wireless vehicle device control and two-way voice communication system is provided comprising a portable fob and a vehicle unit. The fob includes a fob speaker and a fob transceiver, wherein the fob may be configured to transmit a fob user voice signal and at least one control signal, and receive at least one vehicle occupant voice signal. The vehicle unit includes a vehicle transceiver and at least one vehicle speaker, wherein the vehicle transceiver may be configured to transmit the at least one vehicle occupant voice signal, receive the fob user voice signal and the at least one control signal, and control at least one vehicle device in response to the control signal.

Also according to the present invention, in a vehicle having a wireless communication system including vehicle transceiver and a fob having a fob transceiver, a method for vehicle device control and two-way voice communication is provided comprising transmitting a fob user voice signal and at least one control signal from the fob, and receiving at least one vehicle occupant voice signal at the fob, and transmitting the at least one vehicle occupant voice signal from the vehicle transceiver, receiving the fob user voice signal and the at least one control signal, and controlling at least one vehicle operation or device in response to the control signal at the vehicle.

Further according to the present invention, a passive wireless vehicle device control and two-way voice communication system is provided comprising a portable fob and a vehicle unit. The fob includes a fob microphone, a fob speaker and a fob transceiver, wherein the fob may be configured to transmit a fob user voice signal through the fob microphone and transmit at least one control signal, and receive at least one vehicle occupant voice signal through the fob speaker. The vehicle unit includes a vehicle transceiver, a vehicle microphone, and at least one vehicle speaker, wherein the vehicle transceiver may be configured to transmit the at least one vehicle occupant voice signal through the vehicle microphone and receive the fob user voice signal through the at least one vehicle speaker, receive the at least one control signal, and control at least one vehicle device in response to the control signal.

It is therefore an object of the present invention to provide a system that solves the above-noted problems by including two-way voice communication capability to allow the key fob user to perform two-way voice communication operations with the respective vehicle occupants. It is a further object of the present invention to provide wireless “hands free” (or passive) or alternatively, active keyless vehicle device or operation control features, and passive vehicle ignition interface capability.

The above objects and other objects, aspects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a diagram of a key fob communicator system in accordance with the present invention; and

FIG. 2 is a partial view of a vehicle interior in accordance with the present invention.

### DETAILED DESCRIPTION OF THE PREFERRED EMBODIMENT(S)

With reference to the Figures, the preferred embodiments of the present invention will now be described in detail. Generally, the present invention provides a wireless passive (or alternatively, active) remote keyless entry (RKE) system that includes a key fob having two-way voice communication capability to allow the transmitter user to perform two-way voice communication operations with the respective vehicle occupants, active (or alternatively, passive) entry/exit, alarm/anti-theft arm/disarm, etc. capability, and passive vehicle ignition interface capability. The vehicle generally includes vehicle device and operation interface controls, passive vehicle ignition interface controls and two-way voice communication with the key fob.

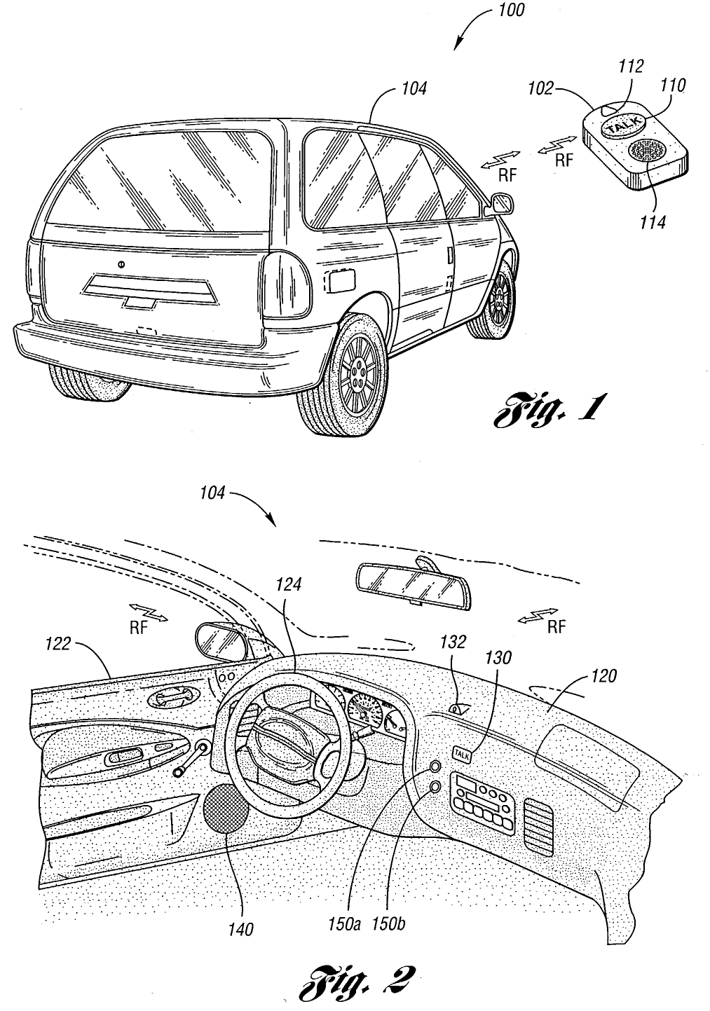

Referring to FIG. 1, a diagram illustrating a wireless key fob communicator system 100 is shown in accordance with the present invention. The system 100 is generally implemented having active (or alternatively, passive) remote keyless vehicle device or operation control and a passive vehicle ignition interface. The system 100 generally comprises a key fob 102 and a vehicle unit 104. The vehicle 104 is generally an automotive product (e.g., car, truck, sport utility vehicle, van, mini-van, multi-purpose vehicle, etc.).

The fob 102 and the vehicle 104 are generally configured to communicate (i.e., transmit and receive) via at least one radio frequency signal (e.g., RF). The signal RF is generally implemented as at least two signals (i.e., at least one two-way voice communication signal and at least one vehicle device or operation control signal). The signal RF may be configured such that a user (not shown) of the key fob 102 may perform two-way voice communication (e.g., talk/listen) with at least one occupant (not shown) of the vehicle unit 104. The signal RF may also be configured to provide control of at least one vehicle device or operation such as active entry/exit (e.g., door lock/unlock, door open/close, alarm/anti-theft device arm/disarm, panic alert, security lighting, etc.), passive entry/exit (e.g., door lock/unlock, door open/close, alarm arm/disarm, security lighting, etc.), and ignition interface (e.g., keyless start enable) in connection with the vehicle 104. At least one segment (or transmission/reception) of the signal RF (e.g., the communication operation) is generally transmitted via a standard communication protocol (e.g., Bluetooth, IEEE 802.11b, etc.). The transmission of the signal RF may be implemented having frequency hopping and spread spectrum transmission technology. The signal RF may be implemented having validation (e.g., authentication and encryption encoding technologies) in connection with the communication protocol. At least one segment (or transmission/reception) of the signal RF (e.g., at least operation or device one control signal) may be implemented as an unencoded or an encoded on/off keyed (OOK) signal. However, the signal RF may be implemented via any appropriate encoding, modulation, communication protocol, etc. to meet the design criteria of a particular application.

The fob 102 is generally configured to be carried by a user (not shown) who leaves the vehicle 104 (i.e., the fob 102 is portable). The fob/communicator 102 generally comprises an operator communication button (or switch) 110, a microphone 112, and a speaker 114. The fob 102 generally further includes a transceiver (not shown) that may be configured to transmit (i.e., send, present, broadcast, etc.) and receive the signal RF.

The button 110 is generally actuated (e.g., pushed) by the user when the user wishes to perform a two-way communication with at least one occupant who remains in the vehicle 104. The fob user generally speaks into the microphone 112 when the button 110 is pushed (e.g., when the user “keys” the mike). The fob 102 generally transmits the signal RF (e.g., an RF signal that is modulated by a voice signal of the fob 102 user) in response to the user voice and actuation of the switch 110. The speaker 114 generally reproduces a voice signal transmitted via the signal RF and generated by the at least one occupant of the vehicle 104 who is communicating with the fob 102 user. In an alternative embodiment (not shown), the speaker 114 may be configured as a multi-purpose transducer that can perform as a microphone as well as a speaker and the microphone 114 may be deleted from the fob 102.

In one example, the fob 102 may be implemented as a passive keyless entry/exit device. The vehicle 104 may be configured to unlock/lock at least one door, deck lid, hatch, etc. in response to the signal RF when the fob 102 is brought within (or alternatively, leaves) a predetermined proximity of the vehicle 104. The fob 102 may be implemented having switches (not shown) in addition to the button 110. For example, the fob 102 may comprise a “panic” button (not shown). When the fob 102 user pushes the panic button, the speaker 114 may emit an alarm/alert audio signal. The vehicle 104 may also emit an alarm/alert audio signal in response to the actuation of the fob 102 panic button.

In another example, the fob 102 may comprise a start button (not shown). When the fob 102 is in a predetermined proximity of the vehicle 104, the signal RF may be communicated between the fob 102 and the vehicle 104 such that a remote start feature is enabled (i.e., the system 100 may comprise a passive ignition interface). The enabling of the vehicle 104 remote start operation generally comprises a mutual recognition of the fob 102 and the vehicle 104 via at least one encoded signal transmitted and received version of the signal RF. When the remote start feature has been enabled in the vehicle 104, user actuation of the start switch on the fob 102 may transmit a signal RF that is configured to control a start operation of the vehicle 104.

In yet another example, the fob 102 may be an active remote keyless entry device and the fob 102 may comprise buttons (or switches) that correspond to at least one door lock/unlock, trunk unlatch, alarm arm/disarm, engine start, etc. operation. When the fob 102 user actuates the respective button on the fob 102, the respective signal RF may be presented to the vehicle 104. The vehicle 104 may perform the corresponding device or control operation. However, the communicator fob 102 and the vehicle 104 may be implemented having two-way communicator operation and any appropriate combination of active and passive vehicle device control or operations control (e.g., entry/exit, lock/unlock, alarm/anti-theft, ignition interface, etc.) to meet the design criteria of a particular application.

The two-way voice communication operation of the system 100 may be configured to have a farther range than the control operation such that the fob 102 user and the vehicle 104 occupant may communicate at a greater distance (e.g., three times to one hundred times farther) than the control of the vehicle 104 operations or devices. For example, the control of the vehicle 104 device or operations may generally have a nominal range of approximately 0 to 30 m and a preferred range of approximately 0 to 10 m. The system 100 two-way voice communication may have a nominal range of approximately 0 to 1000 m and a preferred range of approximately 0 to 500 m.

Referring to FIG. 2, a partial interior view of the vehicle unit 104 is shown. The vehicle 104 generally comprises an instrument panel 120, a door 122, and a steering wheel 124. The vehicle 104 may further comprise a transceiver (not shown) that may be configured to communicate (i.e., transmit/receive) the signal RF between the vehicle 104 and the fob/communicator 102, provide the passive vehicle ignition interface, and provide the active and passive vehicle device and operation control interface.

The instrument panel 120 generally comprises an occupant communication button (or switch) 130 and a microphone 132. The door 122 generally comprises at least one speaker 140. The speaker 140 may also be implemented in connection with a vehicle entertainment system (not shown). In one example (e.g., a passive vehicle ignition start/stop implementation of the system 100), the instrument panel 120 may further comprise vehicle (or engine) start/stop switches (or buttons) 150a/150b. In one example (e.g., a vehicle 104 having a “hands free” cellular phone implementation), the microphone 132 and the speaker 140 may be implemented in connection with the cellular phone apparatus. The microphone 132 and the speaker 140 may be configured to operate alternatively with the system 100 communication operation, cellular telephone operation, and, in the case of the speaker 140, with the vehicle entertainment system.

The locations of the button 130, the microphone 132, the speaker 140, and the buttons 150a/150b shown in FIG. 2 are illustrative. The button 130, the microphone 132, the speaker 140, and the buttons 150a/150b may be positioned at any appropriate location in the vehicle 104 to meet the design criteria of a particular application. For example, the microphone 132 may be positioned in a vehicle 104 headliner (not shown), visor (not shown), console (not shown), on the steering wheel 124, etc. The speaker 140 may be positioned on the instrument panel 120, in the headliner, etc. In an alternative implementation, the speaker 140 may be implemented as a multi-purpose transducer that can perform as a microphone as well as a speaker and the microphone 132 may be deleted from the system 100. The buttons 150a/150b may be positioned on the steering wheel 124, on a steering column, etc.

When the vehicle 104 occupant wishes to communicate with the user who has the fob 102, the occupant may activate (e.g., push) the button 130. The signal RF may be generated carrying (i.e., modulated by) a voice signal of the vehicle 104 occupant as received by the microphone 132 (or alternatively, the speaker 140) and transmitted. The signal RF may be received by the fob 102 and reproduced by the speaker 114. The fob 102 user may perform two-way voice communication with the occupant of the vehicle 104 via the system 100.

When the vehicle unit 104 receives the appropriate control signal RF (either actively in response to user actuation of a fob 102 switch or alternatively, passively) the vehicle 104 transceiver is generally configured to respond by performing or controlling the respective operation or device control (e.g., lock/unlock, start enable, alarm/anti-theft arm/disarm, etc.).

Thus, the present invention may provide an improved system (e.g., the system 100) and an improved method of interfacing between a vehicle, at least one vehicle occupant, and a user who is not in the vehicle. The system 100 may provide two-way voice communication between at least one vehicle occupant and a user who is not in the vehicle in combination with operations such as active (or alternatively, passive) control of vehicle operations or devices (e.g., lock/unlock, start enable, alarm/anti-theft arm/disarm, etc.).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A wireless vehicle device control and two-way voice communication system comprising:
a portable fob including a fob speaker and a fob transceiver, wherein the fob is configured to transmit a fob user voice signal and at least one control signal, and receive at least one vehicle occupant voice signal; and
a vehicle unit including a vehicle transceiver and at least one vehicle speaker, wherein the vehicle transceiver is configured to transmit the at least one vehicle occupant voice signal, receive the fob user voice signal and the at least one control signal, and control at least one vehicle device in response to the control signal.

2. The system of claim 1 wherein the fob further comprises a fob microphone configured to receive the fob user voice signal.

3. The system of claim 1 wherein the vehicle further comprises a vehicle microphone configured to receive the at least one vehicle occupant voice signal.

4. The system of claim 1 wherein the control signal comprises a passive control signal.

5. The system of claim 1 wherein the control signal comprises an active control signal.

6. The system of claim 1 wherein the control signal comprises a passive engine ignition start enable signal.

7. The system of claim 1 wherein the vehicle speaker is alternatively a cellular phone speaker.

8. The system of claim 1 wherein the vehicle speaker is alternatively a vehicle entertainment system speaker.

9. The system of claim 1 wherein the fob and the vehicle occupant voice signals and the control signal are transmitted using a Bluetooth or an IEEE 802.11b protocol.

10. The system of claim 1 wherein communication range for the fob and the vehicle occupant voice signals is three times to one hundred times greater than communication range for the control signal.

11. In a vehicle having a wireless communication system including a vehicle transceiver and a fob having a fob transceiver, a method for vehicle device control and two-way voice communication comprising:
transmitting a fob user voice signal and at least one control signal from the fob, and receiving at least one vehicle occupant voice signal at the fob; and
transmitting the at least one vehicle occupant voice signal from the vehicle transceiver, receiving the fob user voice signal and the at least one control signal, and controlling at least one vehicle device in response to the control signal at the vehicle.

12. The method of claim 11 wherein at least one of the at least one control signals comprises a passive control signal.

13. The method of claim 11 wherein at least one of the at least one control signals comprises an active control signal.

14. The method of claim 11 wherein at least one of the at least one control signals comprises passive engine ignition start control signal.

15. The method of claim 11 further comprising:
transmitting the fob user voice signal from the fob through a microphone and receiving the fob user voice signal at the vehicle through a vehicle speaker wherein the vehicle speaker is alternatively a cellular phone speaker; and
transmitting the vehicle occupant voice signal from the vehicle through a vehicle microphone wherein the vehicle microphone is alternatively a cellular phone microphone.

16. The method of claim 11 further comprising receiving the fob user voice signal at the vehicle through a vehicle speaker wherein the vehicle speaker is alternatively a vehicle entertainment system speaker.

17. The method of claim 11 wherein the fob user and the vehicle voice signals and the control signal are transmitted using a Bluetooth or an IEEE 802.11b protocol.

18. A passive wireless vehicle device control and two-way voice communication system comprising:
a portable fob including a fob microphone, a fob speaker and a fob transceiver, wherein the fob is configured to transmit a fob user voice signal through the fob microphone and transmit at least one control signal, and receive at least one vehicle occupant voice signal through the fob speaker; and
a vehicle unit including a vehicle transceiver, a vehicle microphone, and at least one vehicle speaker, wherein the vehicle transceiver is configured to transmit the at least one vehicle occupant voice signal through the vehicle microphone and receive the fob user voice signal through the at least one vehicle speaker, receive the at least one control signal, and control at least one vehicle device in response to the control signal.

19. The system of claim 18 wherein at least one of the at least one control signals comprises passive engine ignition start control signal.

20. The system of claim 18 wherein the fob user and the vehicle occupant voice signals and the control signal are transmitted using a Bluetooth or an IEEE 802.11b protocol.
